(19) United States
(12) Patent Application Publication
(10) Pub. No.: US 2024/0206022 A1
(43) Pub. Date: Jun. 20, 2024

(54) INDUCTION ENERGY TRANSMISSION SYSTEM

(71) Applicant: BSH Hausgeräte GmbH, München (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/288,392

(22) PCT Filed: Apr. 27, 2022
(86) PCT No.: PCT/EP2022/061147

§ 371 Date: Oct. 26, 2023

(30) Foreign Application Priority Data
May 3, 2021 (EP) 21382394.1

(51) Int. Cl. H05B 6/06; H05B 6/12

(52) U.S. Cl. CPC H05B 6/062; H05B 6/1236; H05B 6/1272; H05B 2213/06

(57) ABSTRACT

An induction energy transmission system includes a supply unit having a supply induction element designed to inductively provide energy, a placeable unit having an absorbing induction element designed to receive the inductively provided energy, and a control unit designed to control the supply unit. The control unit is designed to receive an operating parameter set of the placeable unit and, based on the operating parameter set, to control the energy provided inductively by the supply unit.

The invention relates to an induction energy transmission system according to the preamble of claim 1, and a method for operating an induction energy transmission system according to the preamble of claim 15.

From the prior art there are known induction energy transmission systems for inductive transmission of energy from a primary coil of a supply unit to a secondary coil of a placeable unit. For example, in the publication U.S. Pat. No. 3,761,668 A, an induction cooking field is proposed which, apart from an inductive heating of cooking equipment is also intended for an energy supply to small household appliances, for example, a mixer. Energy provided inductively by a primary coil of the induction cooking field is therein partially transmitted to a secondary coil integrated into the small household appliance.

In view of the very large number of different placeable units which are able to be supplied with energy inductively, the problem exists with previously known induction energy transmission systems, for each placeable unit, of enabling an individual and demand-based control of the inductively provided energy. In the case, in particular, of relatively complex placeable units, for example, food processors which can be operated at different power levels and, depending upon the operating mode, can sometimes be operated with different types of electrical load in order to provide different functions, the problem has previously existed that in the case of a change of power level and/or type of electrical load to be operated, initially an over-supply or under-supply with inductively provided energy occurs, until a supply power level is adapted to the newly set power and/or load conditions. This leads to undesirable behavior, for example to rotary speed variations during stirring processes or to damaging of mechanical components in the case of an oversupply, by means of which an operating convenience to the user is disadvantageously severely impaired.

The object of the invention lies, in particular but not restricted thereto, in providing a generic system with improved properties with regard to an operating convenience. The object is achieved according to the invention by the features of claims 1 and 15, while advantageous embodiments and developments of the invention are disclosed in the subclaims.

The invention proceeds from an induction energy transmission system, in particular an induction cooking system having a supply unit which has at least one supply induction element for the inductive provision of energy, having a control unit for controlling the supply unit and having at least one placeable unit which has at least one absorbing induction element for a reception of the inductively provided energy.

It is proposed that the control unit is intended to receive at least one operating parameter set of the placeable unit and, on the basis of the operating parameter set, to control the energy provided inductively by way of the supply unit.

With a design of this type, an induction energy transmission system having a particularly high level of operating convenience can advantageously be provided. In that the energy provided inductively by way of the supply unit is controlled by way of the control unit on the basis of the operating parameter set of the placeable unit, a particularly precise and reliable energy supply to the placeable unit can advantageously be achieved. In particular, in the case of relatively complex placeable units having a plurality of power levels and/or different switchable electrical loads, a precise energy supply can be achieved in each operating state. Particularly advantageously, current and/or voltage peaks and an oversupply to the placeable unit with energy in the case of a change from a first operating state to a second operating state of the placeable unit can be prevented. Thus, damage to the placeable unit, for example due to voltage spikes or by way of an overloading of mechanical components due to an oversupply with energy, and also undesirable behavior, for example, rotary speed variations or excessive rotary speeds of a stirrer of the placeable unit, can advantageously be effectively prevented. Thus an induction energy transmission system having a particularly reliable and long-lived placeable unit can be provided and a user-friendliness and operating experience for the user can advantageously be improved.

The induction energy transmission system has at least one main functionality in the form of a wireless energy transmission, in particular in a wireless energy supply to placeable units. In an advantageous embodiment, the induction energy transmission system is designed as an induction cooking system having at least one further main function deviating from a pure cooking function, in particular at least one energy supply to, and an operation of, small household appliances. For example, the induction energy transmission system could be designed as an induction oven system and/or an induction grill system. In particular, the supply unit could be designed as part of an induction oven and/or as part of an induction grill. Preferably, the induction energy transmission system designed as an induction cooking system is designed as an induction cooking field. The supply unit is then designed, in particular, as part of an induction cooking field. In a further advantageous embodiment, the induction energy transmission system is designed as a kitchen energy supply system and can also be intended, apart from a main function in the form of an energy supply and an operation of small household appliances, for providing cooking functions.

A “supply unit” should be understood to mean a unit which provides energy inductively in at least one operating state and which has, in particular, a main functionality in the form of an energy provision. For the provision of energy, the supply unit has at least one supply induction element which has, in particular, at least one coil, in particular at least one primary coil and/or is configured as a coil and which provides inductive energy, in particular in the operating state. The supply unit could have at least two, in particular at least three, advantageously at least four, particularly advantageously at least five, preferably at least eight and particularly preferably a plurality of supply induction elements which could each provide inductive energy in the operating state, specifically in particular to a single absorbing induction element or to at least two or more absorbing induction elements of at least one placeable unit and/or at least one further placeable unit. At least a portion of the supply induction elements could be arranged in a vicinity of one another, for example, in a row and/or in the form of a matrix. Preferably, the supply unit has at least one inverter unit. Preferably, in the operating state, the inverter unit carries out a frequency conversion and, in particular, converts an input-side low frequency alternating voltage into an output-side high frequency alternating voltage. Preferably, the low frequency alternating voltage has a frequency of not more than 100 Hz. Preferably, the high frequency alternating voltage has a frequency of at least 1000 Hz. The inverter unit is connected to the control unit and is able to be controlled by way of the control unit by means of control signals. Preferably, the inverter unit is intended to undertake the adjusting of the energy provided inductively by way of the at least one supply induction element by way of adjusting the high frequency alternating voltage. Preferably, the supply unit comprises at least one rectifier. Preferably, the inverter unit has at least one inverter switch element. Preferably, the inverter switch element for operation of the at least one supply induction element generates an oscillating electric current, preferably with a frequency of at least 15 kHz, in particular at least 17 kHz and advantageously at least 20 kHz. Preferably, the inverter unit comprises at least two inverter switch elements which are preferably designed as bipolar transistors with an insulated gate electrode and particularly advantageously at least one damping capacitor.

A “placeable unit” should be understood to mean a unit which receives inductive energy in at least one operating state and which converts inductively received energy at least partially into at least one further form of energy for providing at least one main function. For example, the inductively received energy could be converted, in particular directly, by the placeable unit in the operating state into at least one further energy form, for example, into heat. Alternatively or additionally, the placeable unit can have at least one electrical consumer, for example, an electric motor or suchlike. The placeable unit has at least one absorbing induction element for receiving the inductively provided energy. The placeable unit could have, for example, at least two, in particular at least three, advantageously at least four, particularly advantageously at least five, preferably at least eight and particularly preferably a plurality of absorbing induction elements which could each receive inductive energy, in particular in the operating state, in particular from the supply induction element. The placeable unit could be designed, for example, as a cooking equipment item. The cooking equipment item preferably has at least one food receptacle and converts the inductively received energy in the operating state at least partially into heat for heating food items arranged in the food receptacle. Preferably, the placeable unit designed as a cooking equipment item has at least one further unit for providing at least one further function which extends beyond a pure heating of food items and/or deviates from a heating of food items. For example, the further unit could be designed as a temperature sensor or as a stirring unit or suchlike. Alternatively, the placeable unit can be configured as a small household appliance. Preferably, the small household appliance is a non-stationary household appliance which has at least the absorbing induction element and at least one functional unit which, in an operating state, provides at least one household appliance function. “Non-stationary” should be understood in this context to mean that the small household appliance is able to be positioned freely by a user in a household and, in particular, without any aids, in particular as distinct from a large household appliance which is fixedly positioned and/or installed at a particular position in a household, for example, an oven or a refrigerator. Preferably, the small household appliance is designed as a small kitchen appliance and, in the operating state, provides at least one main function for the processing of food items. The small household appliance could be designed, for example, as a food processor and/or as a mixer and/or as a stirrer and/or as a grinder and/or as a kitchen weighing scale or as a water boiler or as a coffee machine or as a rice cooker or as a milk frother or as a deep fryer or as a toaster or as a juicer or as a cutting machine or suchlike, but without being restricted thereto.

The absorbing induction element of the placeable unit comprises at least one secondary coil and/or is designed as a secondary coil. In an operating state of the placeable unit, the absorbing induction element supplies at least one consumer of the placeable unit with electrical energy. It is further conceivable that the placeable unit has an energy store, in particular an accumulator which is intended to store electrical energy received via the absorbing induction element in a charging state and, in a discharging state, to provide it for the supply of the functional unit.

Preferably, the induction energy transmission system has at least one placement panel for placing the placeable unit. A “placement panel” should be understood to mean an, in particular, panel-like unit which is intended for a placement of at least one placeable unit and/or for placing at least one cooking object. The placement panel could be designed, for example, as a worktop, in particular as a kitchen worktop or as a portion of at least one worktop, in particular at least one kitchen worktop, in particular of the induction energy transmission system. Alternatively or additionally, the placement panel could be designed as a cooking field panel. The placement panel designed as a cooking field panel could, in particular, form at least a part of a cooking field outer housing and, in particular, together with at least one outer housing unit to which the placement panel designed as a cooking field panel, could, in particular, be connected in at least one mounted state, could at least largely form the cooking field outer housing. Preferably, the placement panel is made of a non-metallic material. The placement panel could be formed at least largely of glass and/or glass ceramics and/or of a Neolith and/or of Dekton and/or of wood and/or of marble and/or of stone, in particular natural stone, and/or of laminated material and/or of plastics and/or of ceramics. In the present application, positional references such as “beneath” or “above” relate to a mounted state of the placement panel, provided this is not otherwise explicitly described otherwise. In the mounted state, the supply unit is preferably arranged beneath the placement panel.

A “control unit” should be understood to mean an electronic unit which is intended to control and/or regulate at least the supply unit. Preferably, the control unit comprises a computing unit and, in particular, in addition to the computing unit, a storage unit with a control and/or regulating program stored therein which is intended to be executed by the computing unit.

An “operating parameter set” should be understood to mean a plurality of at least two operating parameters of the placeable unit, on the basis of which the control unit controls the energy provided inductively by way of the supply unit according to a current operating state of the placeable unit. Preferably, at least one operating parameter of the operating parameter set comprises a design and/or geometric characteristic variable of the placeable unit, in particular the absorbing induction element. Design and/or geometric characteristic variables could therein comprise, for example, a shape and/or a variable, in particular a radius and/or diameter and/or a cross-sectional area and/or a winding count and/or a material and/or a spatial position of the absorbing induction element within the placeable unit, but without being restricted thereto. Preferably, at least one operating parameter of the operating parameter set comprises an electrical characteristic variable of the absorbing induction element, for example, a value of an electric resistance and/or an impedance and/or an inductance and/or a magnetic flux density and/or a resonance frequency and/or a material constant, for example, a magnetic permeability. Preferably, at least one operating parameter of the operating parameter set comprises at least one operating characteristic variable of the placeable unit, for example, a maximum power level and/or a minimum power level and/or a number of power levels and/or a number and/or type of operable electrical loads and/or a voltage and/or current strength needed in an operating state. All the operating parameters of the operating parameter set could be static, that is, at least substantially constant, in particular over an overall operating time period of the placeable unit in which it is supplied inductively with energy by way of the supply unit. For example, a placeable unit could have only one consumer and only one power level, an operating parameter set, the operating parameters of which are all static. Preferably, at least one operating parameter of the operating parameter set is a dynamic operating parameter, which means in particular, temporally adjustable. The dynamic operating parameter could comprise information regarding an adjustment of an operating state of the placeable unit, for example, a type and/or time point of a change in a power level and/or a change in a number and/or type of electrical loads to be operated simultaneously. The dynamic operating parameters could also comprise an information item regarding an adjustment of a position of the absorbing induction element relative to the supply induction element, for example, on the basis of a displacement of the placeable unit on the placement panel by a user.

“Intended” should be understood, in particular, as especially programmed, designed and/or equipped. That an object is intended for a particular function should be understood as meaning that the object fulfils and/or carries out this particular function in at least one use and/or operating state.

It is further proposed that the control unit is intended to receive the operating parameter set of the placeable unit on a temporally recurring basis. By this means, an operating convenience can advantageously be further improved. In particular, a safe and reliable operation of the placeable unit can advantageously be achieved. Preferably, the control unit is intended to receive the operating parameter set of the placeable unit regularly, in particular periodically, on a temporally recurring basis. For example, in the operating state, the control unit could receive the operating parameter set of the placeable unit within each period of an AC supply voltage on a temporally recurring basis.

It is additionally proposed that the control unit is intended, in the case of an adjustment of at least one operating parameter of the operating parameter set, to automatically adapt the energy provided inductively by way of the supply unit. By this means, an operating convenience can advantageously be further improved. Advantageously, damage to and/or undesirable behavior of the placeable unit caused by the adjustment of the operating parameter, can advantageously be effectively prevented if the control unit is intended, in the case of an adjustment of at least one operating parameter of the operating parameter set, to automatically adapt the energy provided inductively by way of the supply unit.

It is further proposed that the induction energy transmission system has a communication unit for wireless data transmission, in particular via NFC, between the placeable unit and the control unit. With an embodiment of this type, an operating convenience can advantageously be further improved. Advantageously, a particularly simple, rapid and reliable data transfer, in particular a simple, rapid and reliable reception of the operating parameter set by the control unit can be enabled. The communication unit is preferably intended for a bidirectional wireless data transfer, that is, both for a wireless reception and also for a wireless transmission of data. Preferably, the communication unit has at least one communication element which is connected to the control unit and is intended, in particular, for a wireless reception and transmission of data. Preferably, the communication unit has at least one further communication element which is arranged within the placeable unit and is intended, in particular, for a wireless reception and transmission of data. The communication unit could be intended for a wireless data transfer between the placeable unit and the control unit via RFID or via Wi-Fi or via Bluetooth or via ZigBee or for wireless data transfer according to another suitable standard. Preferably, the communication unit is intended for a wireless data transfer between the placeable unit and the control unit via NFC. By this means, a particularly future-capable induction energy transmission system can advantageously be provided which is compatible with a large number of placeable units.

It is further proposed that the operating parameter set comprises at least one electrical characteristic variable of the absorbing induction element. By this means, an operating convenience can advantageously be further improved, in particular in that a particularly precise control of the energy provided inductively by the supply unit is enabled on the basis of the electrical characteristic variable of the absorbing induction element. The electrical characteristic variable of the absorbing induction element can be, for example, a value of an electrical resistance and/or an impedance and/or an inductance and/or a magnetic flux density and/or a resonance frequency and/or a material constant, for example, a magnetic permeability of the secondary coil and/or of a circuit of the placeable unit containing the secondary coil.

It is further proposed that the operating parameter set comprises at least one geometric characteristic variable of the absorbing induction element. By this means, an operating convenience can advantageously be further improved, in particular in that a particularly precise control of the energy provided inductively by way of the supply unit is enabled on the basis of the geometric characteristic variable of the absorbing induction element. The geometric characteristic variable can be for example a shape and/or a variable, in particular a radius and/or diameter and/or a cross-sectional area and/or a winding count and/or a material and/or a spatial position of the secondary coil of the absorbing induction element.

It is also proposed that the geometric characteristic variable denotes a diameter of the absorbing induction element. By this means, an operating convenience can advantageously be further improved. In particular, a precision in the control of the inductively provided energy by way of the supply unit can be further improved by way of the control unit on the basis of the operating parameter set. That the geometric characteristic variable “denotes” a diameter of the absorbing induction element should be understood to mean that the diameter of the absorbing induction element is able to be determined by the control unit at least approximately, preferably exactly, from the geometric characteristic variable. The geometric characteristic variable could comprise the diameter of the absorbing induction element. Also conceivable, however, alternatively or additionally is that the geometric characteristic variable comprises information regarding, for example, a semidiameter, in particular a radius and/or a width and depth of the absorbing induction element and/or regarding a total length and winding count of an electrical conductor forming the absorbing induction element, from which the diameter of the absorbing induction element is at least approximately able to be determined.

It is further proposed that the geometric characteristic variable denotes a spacing between the absorbing induction element and the supply induction element. With an embodiment of this type, an operating convenience can advantageously be further improved. In particular, a precision in the control of the energy provided inductively by way of the supply unit can advantageously be further improved by way of the control unit on the basis of the operating parameter set. That the geometric characteristic variable “denotes” a spacing between the absorbing induction element and the supply induction element should be understood to mean that the spacing between the absorbing induction element and the supply induction element is able to be determined by the control unit at least approximately, preferably exactly, from the geometric characteristic variable. The geometric characteristic variable could comprise the spacing between the absorbing induction element and the supply induction element. However, alternatively or additionally, it is also conceivable that the geometric characteristic variable comprises information relating to a spacing of the absorbing induction element from an underside of the placeable unit on which the placeable unit is placed in the operating state, in particular on the placement panel, wherein the spacing between the absorbing induction element and the supply induction element is able to be determined at least approximately from the information.

It is further proposed that the control unit is provided to determine a coupling coefficient between the supply induction element and the absorbing induction element on the basis of the operating parameter set. By this means, an operating convenience can advantageously be further improved. In particular, a precision in the control of the energy provided inductively by way of the supply unit can advantageously be further improved by way of the control unit on the basis of the operating parameter set. That the control unit is provided “to determine” a coupling coefficient between the supply induction element and the absorbing induction element on the basis of the operating parameter set should be understood to mean that, in an operating state, the control unit at least approximately estimates and/or calculates the coupling coefficient on the basis of at least one operating parameter of the operating parameter set. The coupling coefficient which, in the specialist literature, is also sometimes referred to as a coupling factor, preferably describes the proportion of the magnetic flux generated by the supply induction element in the operating state which is linked to the absorbing induction element. The coupling coefficient is dimensionless and can assume values of between 0 and 1, wherein a coupling coefficient of 0 describes a state in which the magnetic flux generated by way of the supply induction element in the operating state is not coupled into the absorbing induction element, and the supply induction element and the absorbing induction element are magnetically isolated from one another, and a coupling coefficient of 1 defines an ideal state in which the magnetic flux generated by the supply induction element in the operating state is completely coupled into the receiving induction element. A value of the coupling coefficient is dependent, apart from the inductances of the supply induction element and the absorbing induction element, in particular, upon the spacing between the supply induction element and the absorbing induction element and upon the diameters of the supply induction element and the absorbing induction element. The control unit is preferably provided to determine the coupling coefficient on the basis of the at least one geometric characteristic variable of the absorbing induction element, which is contained in the operating parameter set at least approximately, for example, by means of an approximation formula which is stored in the storage unit and can be used by the computing unit.

In addition, it is proposed that the placeable unit has at least two switchable electrical loads. By this means, a placeable unit with a high degree of flexibility and a broad functional spectrum can be provided. An “electrical load” of the placeable unit should be understood herein as being at least one electrical consumer of the placeable unit which is connected in electrically conducting manner to the absorbing induction element and which, in an operating state of the placeable unit, in particular for providing at least one function of the placeable unit, converts an electrical energy received inductively by the absorbing induction element from the supply induction element at least partially into at least one further energy form, for example into a thermal energy and/or into a motion energy and/or suchlike. The electrical load can be a resistive load which could comprise, for example, at least one heating element of the placeable unit for providing a heating function. Alternatively or additionally, the electrical load can be an inductive load which could comprise, for example, an electric motor for a driving of a stirring unit of the placeable unit. It is also conceivable, alternatively or additionally, that the electrical load is a capacitive load which could comprise, for example, a capacitive sensor in the placeable unit or a damping capacitor within an electric circuit of the placeable unit. The electrical load can be assembled from one or more resistive and/or inductive and/or capacitive subloads which preferably cooperate in the operating state for providing the function of the placeable unit. The at least two switchable electrical loads are provided at least for providing a first function of the placeable unit in at least two different power levels, for example, a provision of a heating function in at least two different heat levels. Preferably, the at least two switchable electrical loads are provided for providing at least two different functions of the placeable unit, for example a first function in the form of a heating function and a second function in the form of a stirring function. Preferably, the placeable unit has at least one switch element which, in a closed state, electrically conductively connects the switchable loads to one another. By means of the switch element, at least one of the electrical loads can be switched on or off. It is also conceivable that the electrical loads are able to be operated separately from one another by means of a switch element. For example, in a first operating state of the placeable unit, a first function is able to be provided by means of a first electrical load and in a second operating state, a second function is able to be provided by means of a second electrical load and/or a combination of the first and the second electrical load.

It is further proposed that the operating parameter set comprises at least one characteristic variable of the electrical loads. By this means, an operating convenience can advantageously be further improved. In particular, a precise control of the load inductively provided by the supply unit is advantageously enabled, dependent upon the operating state of the placeable unit, if the operating parameter set comprises at least one characteristic variable of the electrical loads. The characteristic variable of the electrical loads can be a value of an electrical resistance and/or an impedance and/or an inductance and/or a capacitance of at least one subload of the electrical loads, but without being restricted thereto. It is also conceivable that the characteristic variable is a required power level and/or necessary voltage and/or current strength of at least one of the electrical loads in an operating state.

It is further proposed that the operating parameter set comprises at least one switch-over time point between the electrical loads. By this means, an operating convenience can advantageously be further improved. In particular, a particularly soft switch-over between the electrical loads can advantageously be achieved and thus a particularly gentle and fault-free operation of the placeable unit can be enabled. Furthermore, an induction energy transmission system can advantageously be provided with improved properties with regard to an electromagnetic compatibility. Preferably, the control unit is provided to receive the switch-over time point in advance from the placeable unit and on the basis of the adjustment of the at least one operating parameter of the operating parameter set to adapt the energy provided inductively by way of the supply unit exactly at the switch-over time point.

It is also proposed that the placeable unit can be configured as a small household appliance. By this means, advantageously, an induction energy transmission system can be provided with a particularly high level of functionality and flexibility.

In a further advantageous embodiment, it is proposed that the placeable unit is configured as a cooking equipment item. By this means, an induction energy transmission system can advantageously be made available with a particularly high level of operating convenience, in particular with regard to a precise control of an energy provided inductively by way of the supply unit, for heating food items arranged in the cooking equipment.

The invention further proceeds from a method for operating an induction energy transmission system, in particular according to one of the embodiments described above, having a supply unit which has at least one supply induction element for the inductive provision of energy and having at least one placeable unit which has at least one absorbing induction element for a reception of the inductively provided energy.

It is proposed that at least one operating parameter set of the placeable unit is received and the energy provided inductively by way of the supply unit is controlled on the basis of the operating parameter set. With a method of this type, a particularly convenient, safe and reliable operation of the induction energy transmission system can advantageously be enabled.

The induction energy transmission system should not thereby be restricted to the use and embodiment described above. In particular, the induction energy transmission system can have, for a fulfillment of a functional method described herein, a number of individual elements, components and units deviating from a number mentioned herein.

Further advantages are revealed in the following description of the drawings. The drawings show two exemplary embodiments of the invention. The drawings, the description and the claims contain numerous features in combination. A person skilled in the art would also suitably consider the features individually and group them into further useful combinations.

In the drawings:

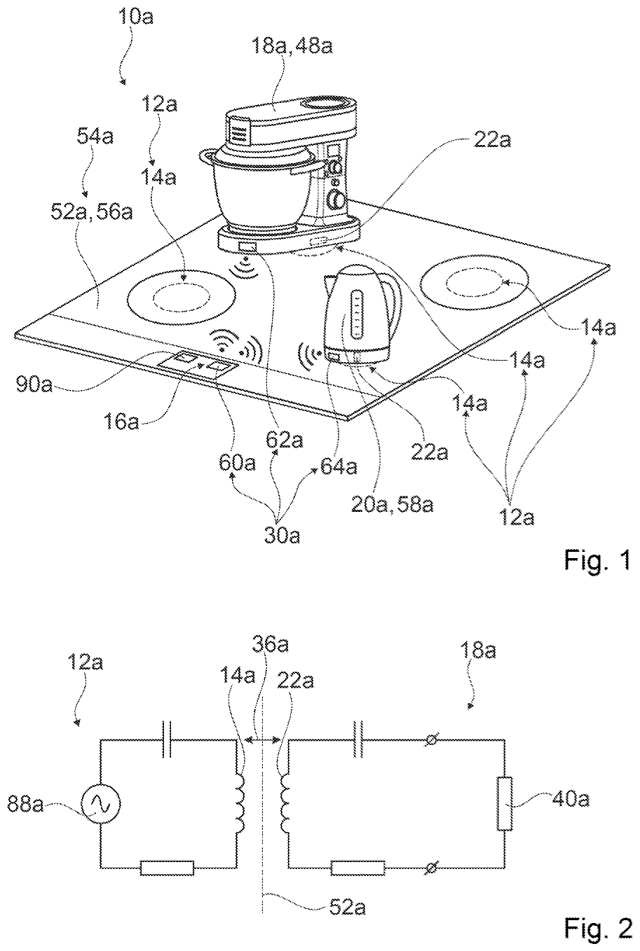

FIG. 1 shows an induction energy transmission system having a supply unit, a control unit, a placeable unit and a further placeable unit in a schematic representation.

FIG. 2 shows a schematic equivalent electrical circuit diagram of an inductive energy transmission between a supply induction element of the supply unit and an absorbing induction element of the placeable unit,

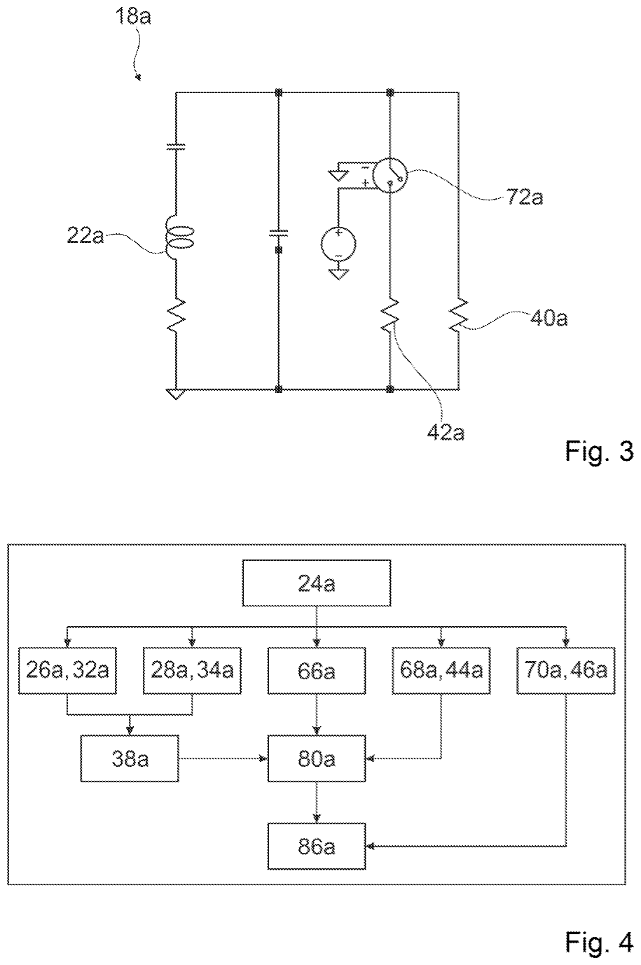

FIG. 3 shows a schematic electrical circuit diagram of an electrical circuit having the absorbing induction element and two switchable electrical loads of the placeable unit.

FIG. 4 shows a schematic diagram to illustrate an operating parameter set of the placeable unit,

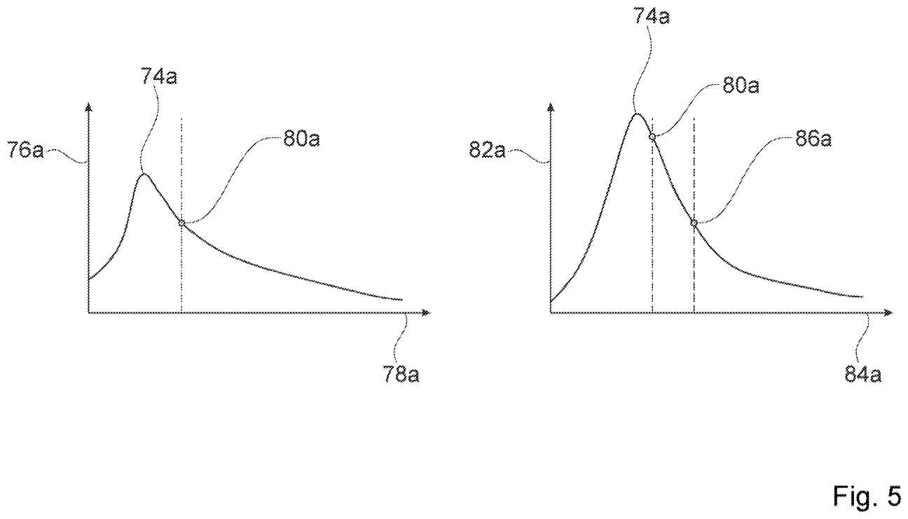

FIG. 5 shows two schematic diagrams to illustrate a power curve of the supply induction element of the supply unit.

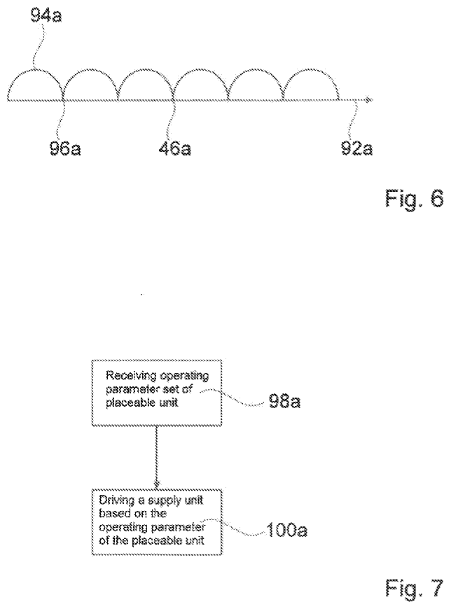

FIG. 6 shows a schematic diagram to illustrate a switch-over time point between the electrical loads of the placeable unit,

FIG. 7 shows a schematic diagram to illustrate a method for operating the induction energy transmission system, and

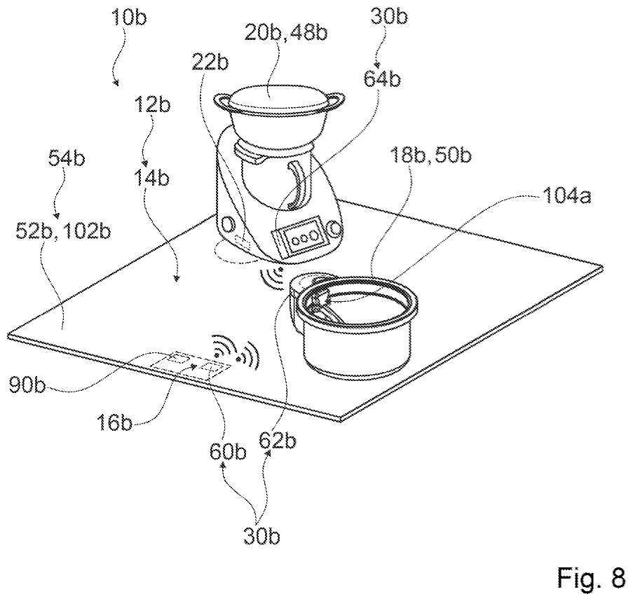

FIG. 8 shows a further exemplary embodiment of an induction energy transmission system having a supply unit, a control unit of a placeable unit and a further placeable unit in a schematic representation.

FIG. 1 shows an induction energy transmission system 10a in a schematic representation. The induction energy transmission system 10a comprises a supply unit 12a. The supply unit 12a has at least one supply induction element 14a for the inductive provision of energy. In the present case, the supply unit 12a comprises in total four supply induction elements 14a, although any other desired number is also conceivable.

The induction energy transmission system 10a has a control unit 16a for controlling the supply unit 12a.

The induction energy transmission system 10a has a placement panel 52a.

The induction energy transmission system 10a is designed in the present case as an induction cooking system and comprises an induction cooking field 54a. In the present case, the placement panel 52a is designed as a cooking field panel 56a. The cooking field panel 56a is part of the induction cooking field 54a.

The induction energy transmission system 10a has a placeable unit 18a. The placeable unit 18a has an absorbing induction element 22a for reception of the energy provided inductively by way of the supply unit 12a. In the present case, the placeable unit 18a is designed as a small household appliance 48a, specifically as a food processor. In the present case, the induction energy transmission system 10a has a further placeable unit 20a. The further placeable unit 20a also comprises an absorbing induction element 22a for reception of the energy provided inductively by way of the supply unit 12a. In the present case, the further placeable unit 20a is designed as a further small household appliance 58a, specifically as a water boiler.

The control unit 16a is provided to receive at least one operating parameter set 24a (see FIG. 4) of the placeable unit 18a and, on the basis of the operating parameter set 24a, to control the energy provided inductively by way of the supply unit 12a. The control unit 16a comprises a computing unit 90a having a program (not shown) that is able to be executed therein for evaluating the operating parameter set 24a.

The induction energy transmission system 10a has a communication unit 30a. The communication unit 30a is provided for a wireless data transfer between the placeable unit 18a and the control unit 16a. In the present case, the communication unit 30a is also provided for a wireless data transfer between the further placeable unit 20a and the control unit 16a. The communication unit 30a has a communication element 60a which is connected to the control unit 16a and is provided for a wireless transmission and reception of data. The communication unit 30a has a further communication element 62a which is arranged in the placeable unit 18a and is provided for a wireless transmission and reception of data. The communication unit 30a also has a further communication element 64a which is arranged in the further placeable unit 20a and is provided for a wireless transmission and reception of data. In the present case, the communication unit 30a is designed as an NFC communication unit and is provided for a wireless data transfer via NFC between the control unit 16a and the placeable unit 18a and/or the further placeable unit 20a.

In an operating state of the induction energy transmission system 10a, the control unit 16a receives the operating parameter set 24a of the placeable unit 18a (see FIG. 4) wirelessly, specifically via the communication unit 30a.

The control unit 16a is provided to receive the operating parameter set 24a on a temporally recurring basis. In the present case, the control unit 16a receives the operating parameter set 24a from the placeable unit 18a at regular temporal intervals, specifically wirelessly via the communication unit 30a.

FIG. 2 shows a schematic equivalent electrical circuit diagram to illustrate an inductive energy transmission between the supply induction element 14a and the absorbing induction element 22a. The supply unit 12a has at least one inverter unit 88a for supplying the supply unit 12a with an alternating current. In the operating state, the control unit 16a controls the energy provided inductively by way of the supply induction element 14a by means of an adjustment of the frequency of the alternating current provided by way of the inverter unit 88a. In the operating state, the supply induction element 14a generates an alternating electromagnetic field by way of which the energy is provided inductively. In the operating state, the absorbing induction element 22a is arranged at a spacing 36a from the supply induction element 14a. In the operating state, a magnetic flux of the alternating electromagnetic field that is generated by way of the supply induction element 14a, is at least partially coupled into the absorbing induction element 22a, so that an alternating voltage is induced in the absorbing induction element 22a and so at least part of the inductively provided energy is received. The placeable unit 18a has at least one electrical load 40a. In the operating state, the electrical load 40a is supplied with the alternating voltage induced in the absorbing induction element 22a.

FIG. 3 shows a schematic electrical circuit diagram of the placeable unit 18a. In the present case, the placeable unit 18a has at least two switchable electrical loads, specifically the electrical load 40a and a further electrical load 42a. The placeable unit 18a has a switch element 72a. The switch element 72a is provided for switching the further electrical load 42a on and off. In a first switching state, the switch element 72a is closed and both the electrical load 40a and also the further electrical load 42a are connected in electrically conducting manner to the absorbing induction element 22a. In a second switching state, the electrical load 40a is connected in electrically conducting manner to the absorbing induction element 22a and the further electrical load 42a is not connected to the absorbing induction element 22a.

FIG. 4 shows a schematic diagram to illustrate the operating parameter set 24a. The operating parameter set 24a comprises an operating parameter 26a and a plurality of further operating parameters 28a, 66a, 68a, 70a.

The operating parameter set 24a comprises at least one electrical characteristic variable 32a of the absorbing induction element 22a of the placeable unit 18a. In the present case, the operating parameter 26a includes the electrical characteristic variable 32a. The electrical characteristic variable 32a comprises at least one inductance of the absorbing induction element 22a.

The operating parameter set 24a further comprises at least one geometric characteristic variable 34a of the absorbing induction element 22a. The geometric characteristic variable 34a denotes a diameter (not shown) of the absorbing induction element 22a. The geometric characteristic variable 34a also denotes the spacing 36a (see FIG. 2) between the absorbing induction element 22a and the supply induction element 14a.

The control unit 16a is provided to determine a coupling coefficient 38a between the supply induction element 14a and the absorbing induction element 22a on the basis of the operating parameter set 24a. In the present case, in the operating state, the control unit 16a determines the coupling coefficient 38a from the electrical characteristic variable 32a and the geometric characteristic variable 34a. The control unit 16a determines the coupling coefficient 38a by means of an approximation formula in the program of the computing unit 90a. The coupling coefficient 38a describes the proportion of the magnetic flux generated by the supply induction element 14a in the operating state, which is coupled to the absorbing induction element 22a (see FIG. 2). The coupling coefficient 38a is dimensionless and can take values of between 0 and 1. The larger the coupling coefficient 38a is, the greater is the proportion of the energy provided inductively by way of the supply induction element 14a which can be received by the absorbing induction element 22a in the operating state.

The operating parameter 66a comprises an electrical power level that is currently demanded by the placeable unit 18a in the operating state.

The operating parameter set 24a comprises at least one characteristic variable 44a of the electrical loads 40a, 42a. In the present case, each characteristic variable 44a comprises a current information item relating to the type and a value of an electrical resistance of the electrical total load that is currently to be powered, which is composed, dependent upon the switching state of the switch element 72a (see FIG. 3), only of the electrical load 40a or a combination of the electrical load 40a with the further electrical load 42a.

The operating parameter set 24a comprises a switch-over time point 46a between the electrical loads 40a, 42a. The switch-over time point 46a defines a time point at which the switch element 72a is switched over. For the second switching state of the switch element 72a, if the switch element 72a is closed, the control unit 16a in the operating state determines, on the basis of the operating parameter set 24a, a first operating point 80a for controlling the energy provided inductively by way of the supply unit 12a.

In the case of an adjustment of at least one operating parameter 26a, 28a, 66a, 68a, 70a of the operating parameter set 24a, the control unit 16a is provided to automatically adapt the energy provided inductively by way of the supply unit 12a. In the present exemplary embodiment, a switch-over of the switch element from the first switching state into the second switching state entails an adjustment of the operating parameter 68a, specifically an adjustment of the characteristic variable 44a with respect to a total load that is to be powered. In the operating state, the control unit 16a determines, starting from the first operating point 80a, a second operating point 86a, on the basis of which a control of the energy provided inductively by way of the supply unit 12a is to take place from the switch-over time point 46a.

FIG. 5 shows two schematic graphs to represent a power curve 74a of the energy provided inductively by way of the supply induction element 14a. Indicated on an ordinate 76a of the left-hand graph is a power, in watts, of the energy that can be provided inductively by the supply induction element 14a. Indicated on an abscissa 78a of the left-hand diagram is a frequency, in kilohertz, of the alternating current with which the inverter unit 88a (see FIG. 2) can be driven by way of the control unit 16a. Entered on the left-hand graph is the first operating point 80a. The first operating point 80a corresponds to a frequency at which the control unit 16a drives the inverter unit 88a to supply the supply induction element 14a in the first switching state of the switch element 72a of the placeable unit 18a.

Indicated on an ordinate 82a of the right-hand graph is the power, in watts, of the energy that can be provided inductively by the supply induction element 14a. Indicated on an abscissa 84a of the right-hand diagram is a frequency, in kilohertz, of the alternating current with which the inverter unit 88a can be driven by way of the control unit 16a. Entered on the right-hand graph is the first operating point 80a and the second operating point 86a. The second operating point corresponds to a frequency at which the control unit 16a drives the inverter unit 88a to supply the supply induction element 14a in the second switching state of the switch element 72a of the placeable unit 18a. As is evident in the right-hand graph, the power level of the energy provided inductively by way of the supply induction element 14a at the second operating point 86a corresponding to the lower overall electrical load of the placeable unit 18a in the second switching state of the switch element 72a is lower than the power level of the inductively provided energy at the first operating point 80a by the supply induction element 14a.

FIG. 6 shows a schematic graph to illustrate the switch-over time point 46a between the switchable electrical loads 40a, 42a of the placeable unit 18a. Indicated on an abscissa 92a of the graph is time in milliseconds. A curve 94a represents a pattern of a rectified mains voltage with which the control unit 16a operates the inverter unit 88a (see FIG. 2).

The control unit 16a is provided to receive the operating parameter set 24a on a temporally recurring basis. In the present case, the control unit 16a receives the operating parameter set 24a from the placeable unit 18a at regular temporal intervals, specifically wirelessly via the communication unit 30a (see FIG. 1). In the present case, the control unit 16a receives the operating parameter set 24a on a temporally recurring basis at the start of each period of the rectified mains voltage, therefore in the case of a mains frequency typical for Europe of 50 Hz, every 20 milliseconds. At a receiving time point 96a, the control unit 16a receives the operating parameter set 24a in the operating state. At the switch-over time point 46a, the control unit 16a automatically adapts the energy provided inductively by way of the supply unit 12a, specifically on the basis of the adjustment of the operating parameter 68a (see FIG. 4). During the receiving time point 96a, the control unit 16a drives the supply unit 12a at the first operating point 80a (see FIG. 5). During the period between the receiving time point 96a and the switch-over time point 46a, the control unit 16a determines the second operating point 96a. From the switch-over time point 46a, the control unit 16a drives the supply unit 12a at the second operating point 86a.

FIG. 7 shows a schematic diagram to illustrate a method for operating the induction energy supply system 10a. In the method, the operating parameter set 24a is received and the energy provided inductively by way of the supply unit 12a is controlled on the basis of the operating parameter set 24a. The method comprises two method steps. In a first method step 98a, the operating parameter set 24a is received, specifically wirelessly by means of the communication unit 30a. In the first method step 98a, the placeable unit 18a transmits the operating parameter set 24a by means of the further communication element 62a to the communication element 60a which is connected to the control unit 16a (see FIG. 1). In a further method step 100a, the operating parameter set 24a is processed by the control unit 16a, specifically by means of the computing unit 90a, and the control unit 16a subsequently drives the supply unit 12a on the basis of the operating parameter set 24a.

FIG. 8 shows a further exemplary embodiment of the invention. The following descriptions are essentially restricted to the differences between the exemplary embodiments, wherein with regard to components, features and functions which remain the same, reference can be made to the description of the exemplary embodiment in FIGS. 1 to 7. In order to differentiate the exemplary embodiments, the letter a in the reference characters of the exemplary embodiment of FIGS. 1 to 7 is replaced by the letter b in the reference characters of the exemplary embodiment of FIG. 8. With regard to components that are identified identically, in particular with regard to components with the same reference characters, in principle, reference can be made to the drawings and/or the description of the exemplary embodiment of FIGS. 1 to 7.

FIG. 8 shows a further exemplary embodiment of an induction energy transmission system 10b in a schematic representation. The induction energy transmission system 10b has a supply unit 12b. The supply unit 12b has at least one supply induction element 14b for the inductive provision of energy. In the present case, the supply unit 12b comprises altogether two supply induction elements 14b.

The induction energy transmission system 10b has a control unit 16b for controlling the supply unit 12b.

The induction energy transmission system 10b has a placement panel 52b. As distinct from the previous exemplary embodiment, the placement panel 52b is designed as a kitchen worktop 102b.

The induction energy transmission system 10b is designed in the present case as an induction cooking system and comprises an induction cooking field 54b (not visible). The kitchen worktop 102b is part of the (not visible) induction cooking field 54b.

The induction energy transmission system 10b has a placeable unit 18b. As distinct from the previous exemplary embodiment, the placeable unit 18b is designed as a cooking equipment item 50b. The cooking equipment item 50b is provided for heating food items (not shown). The cooking equipment item 50b also has a further unit 104b for providing at least one further function which extends beyond a pure heating of food items. In the present case, the further item 104b is configured as a stirring unit and is provided for stirring food items. The placeable unit 18b designed as a cooking equipment item 50b has an absorbing induction element 22b for reception of the energy provided inductively by way of the supply unit 12b.

The induction energy transmission system 10b has a further placeable unit 20b. The further placeable unit 20b has an absorbing induction element 22b for reception of the energy provided inductively by way of the supply unit 12b. The further placeable unit 20b is designed as a small household appliance 48b, specifically as a food processor.

The control unit 16b is provided to receive at least one operating parameter set (not shown) of the placeable unit 18b and, on the basis of the operating parameter set, to control the energy provided inductively by way of the supply unit 12b. The induction energy transmission system 10b comprises a communication unit 30b for a wireless data transfer between the control unit 16b and the placeable unit 18b and/or the further placeable unit 20b. The communication unit 30b comprises a communication element 60b which is connected to the control unit 16b. The communication unit 16b comprises a further communication element 62b which is arranged in the placeable unit 18b, and a further communication element 64b which is arranged in the further placeable unit 20b.

In an operating state of the induction energy transmission system 10b, the operating parameter set is transmitted wirelessly from the further communication element 62b in the placeable unit 18b to the communication element 60b and thus to the control unit 16b.

The control unit 16b comprises a computing unit 90b with a program (not shown) that is able to be executed therein for evaluating the operating parameter set. With regard to a fundamental mode of operation of the control of the supply unit 12b on the basis of the operating parameter set of the placeable unit 18b by the control unit 16b, reference can be made to the description above of the above-described exemplary embodiment of FIGS. 1 to 7.

### REFERENCE CHARACTERS

10 Induction energy transmission system
12 Supply unit
14 Supply induction element
16 Control unit
18 Placeable unit
20 Further placeable unit
22 Absorbing induction element
24 Operating parameter set
26 Operating parameter
28 Operating parameter
30 Communication unit
32 Electric characteristic variable
34 Geometric characteristic variable
36 Spacing
38 Coupling coefficient
40 Electrical load
42 Further electrical load
44 Characteristic variable
46 Switch-over time point
48 Small household appliance
50 Cooking equipment
52 Placement panel
54 Induction cooking field
56 Cooking field panel
58 Further small household appliance
60 Communication element
62 Further communication element
64 Further communication element
66 Operating parameter
68 Operating parameter
70 Operating parameter
72 Switch element
74 Power curve
76 Ordinate
78 Abscissa
80 First operating point
82 Ordinate
84 Abscissa
86 Second operating point
88 Inverter unit
90 Computing unit
92 Abscissa
94 Curve
96 Receiving time point
98 First method step
100 Second method step
102 Kitchen worktop

1-15. (canceled)

16. An induction energy transmission system, in particular an induction cooking system, comprising:
a supply unit comprising a supply induction element designed to inductively provide energy;
a placeable unit comprising an absorbing induction element designed to receive the inductively provided energy; and
a control unit designed to control the supply unit, said control unit designed to receive an operating parameter set of the placeable unit and, based on the operating parameter set, to control the energy provided inductively by the supply unit.

17. The induction energy transmission system of claim 16, wherein the control unit is designed to receive the operating parameter set of the placeable unit on a temporally recurring basis.

18. The induction energy transmission system of claim 16, wherein the control unit is designed to automatically adapt the energy provided inductively by the supply unit, when an operating parameter of the operating parameter set is adjusted.

19. The induction energy transmission system of claim 16, further comprising a communication unit designed to wirelessly transfer data between the placeable unit and the control unit.

20. The induction energy transmission system of claim 16, further comprising a communication unit designed to wirelessly transfer data via NFC (Near Field Communication) between the placeable unit and the control unit.

21. The induction energy transmission system of claim 16, wherein the operating parameter set comprises an electrical characteristic variable of the absorbing induction element.

22. The induction energy transmission system of claim 16, wherein the operating parameter set comprises a geometric characteristic variable of the absorbing induction element.

23. The induction energy transmission system of claim 22, wherein the geometric characteristic variable denotes a diameter of the absorbing induction element.

24. The induction energy transmission system of claim 22, wherein the geometric characteristic variable denotes a spacing between the absorbing induction element and the supply induction element.

25. The induction energy transmission system of claim 16, wherein the control unit is designed to determine a coupling coefficient between the supply induction element and the absorbing induction element based on the operating parameter set.

26. The induction energy transmission system of claim 16, wherein the placeable unit comprises at least two switchable electrical loads.

27. The induction energy transmission system of claim 26, wherein the operating parameter set comprises at least one characteristic variable of the at least two switchable electrical loads.

28. The induction energy transmission system of claim 26, wherein the operating parameter set comprises a switch-over time point between the at least two switchable electrical loads.

29. The induction energy transmission system of claim 16, wherein the placeable unit is designed as a small household appliance.

30. The induction energy transmission system of claim 16, wherein the placeable unit is designed as a cooking equipment item.

31. A method for operating an induction energy transmission system, the method comprising:
inductively provide energy by a supply induction element of a supply unit;
receiving the inductively provided energy by an absorbing induction element of placeable unit; and
controlling the inductively provided energy based on a received operating parameter set of the placeable unit.

32. The method of claim 31, further comprising transmitting the operating parameter set of the placeable unit on a temporally recurring basis.

33. The method of claim 31, further comprising automatically adapting the energy provided inductively by way of the supply unit, when an operating parameter of the operating parameter set is adjusted.

34. The method of claim 31, further comprising wirelessly transferring data between the placeable unit and the control unit.

35. The method of claim 32, further comprising determining, based on the operating parameter set, a coupling coefficient between the supply induction element of the supply unit and the absorbing induction element of the placeable unit.
